(19) United States
(12) Patent Application Publication
(10) Pub. No.: US 2022/0268991 A1
(43) Pub. Date: Aug. 25, 2022

(54) Single-Mode Crystal Fiber

(71) Applicant: National Taiwan University, Taipei (TW)

(72) Inventors: Teng-I Yang, Tainan (TW); Yu-Chan Lin, New Taipei City (TW); Sheng-Lung Huang, Taipei (TW)

(21) Appl. No.: 17/207,852

(22) Filed: Mar. 22, 2021

(30) Foreign Application Priority Data
Feb. 23, 2021 (TW) 110106341

(51) Int. Cl. G02B 6/02; C01F 17/34; D01F 8/18

(52) U.S. Cl. CPC G02B 6/02395; C01F 17/34; D01F 8/18; D10B 2101/06

(57) ABSTRACT

A single-mode crystal fiber is provided. The fiber has a core. The core is made of a crystalline material with a melting point above 1900 degrees Celsius (° C.). The core has a coat. The coat is made of a crystalline material the same as that of the core. Through immersion plating under a low vacuum pressure and a high temperature, the material of the coat is sintered to form an outer layer covering the core. Thus, the thickness of the coat is controlled. A single crystal totally the same as that of the core is grown in a solid state with no ceramics contained. Consequently, the crystal contains no ceramics; and, through being sintered in a vacuum environment, the crystal has pores the smallest in size and the fewest in number, as compared to those sintered under a normal pressure.

### TECHNICAL FIELD OF THE INVENTION

The present invention relates to a crystal fiber; more particularly, to using immersion plating to cover a core with a coat having the same material, where sintering is processed under vacuum and high temperature after immersion plating to obtain the coat of a single crystal totally the same as the material of the core as being grown in a solid state with no ceramics contained.

### DESCRIPTION OF THE RELATED ARTS

Single-mode fiber is a key component in many applications, like big gain active components, high-efficiency lasers, and high-illuminance light sources. For fiber amplifiers, single-mode transmission is an important way to avoid gain competition.

Conventionally, double-coated optical fibers are made of glass. But they have the following disadvantages:

1. Currently for high-power laser input or output, general optical fibers are made of glass and cannot withstand high-wattage laser input or output.

2. Generally, the single-mode fiber has a very small single-mode band range. There is almost no glass-fiber coat that has the same dispersion curve and high refractive index as the core.

3. Since the general core and coat of optical fiber are made of glass, their heat dissipation is poor as compared to crystal fiber.

To solve the above problems, a prior art is proposed where immersion plating is used to cover optical fiber with crystal and, then, sintering is processed in the air at a temperature of 1750 degrees Celsius (° C.). However, the disadvantages of this prior art is that the powder size of the solvent is large and the sintering environment for operation requires a normal pressure (i.e. 1 atmosphere)—not a vacuum environment. Hence, some small holes will be formed during sintering with a ceramic structure next to it, which causes light scattering and transmission loss when used at high wattage. Besides, after processing sintering at a low temperature, the coat formed is a ceramic, where a single-mode crystal structure is not obtained for both of the core and the coat. Hence, the prior arts do not fulfill all users' requests on actual use.

### SUMMARY OF THE INVENTION

The main purpose of the present invention is to process sintering under vacuum and high temperature after immersion plating to fabricate a coat with the thickness under control, where the coat is made of a single crystal totally the same as the material of a core as being grown in a solid state as no ceramics contained; and, through being sintered in a vacuum environment, the crystal has pores the smallest in size and the fewest in number as compared to those sintered under normal pressures.

Another purpose of the present invention is to use the core and the coat both of the same crystal structure to withstand high-power laser input or output, where, because the coat and the core are of the same material with the same dispersion curve, a broadband single-mode range is thus obtained; and the laser is thus suitable for modulated single-mode lasers.

Another purpose of the present invention is to use crystal for a better dissipation than glass, where, as compared to coat glass with fiber, a better dissipation is thus obtained and low conversion efficiency due to thermal effect is reduced.

Another purpose of the present invention is to make all sizes of crystal fibers with the sizes of coat adjustable according to requirement.

Another purpose of the present invention is to obtain lower transmission loss than those of copper cables to be suitable for high-energy transmission.

To achieve the above purposes, the present invention is a single-mode crystal fiber, comprising a core and a coat, where the core is made of a crystalline material with a melting point above 1900 degrees Celsius (° C.); through immersion plating and sintering under a vacuum pressure and a high temperature above 1800° C., a material of the coat the same as that of the core is obtained to form an outer layer covering the core; the thickness of the coat is between 0.05 micrometers (μm) and 10 millimeters (mm); and a single crystal of the coat totally the same as the material of the core is grown in a solid state with no ceramics contained. Accordingly, a novel single-mode crystal fiber is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention; and

FIG. 2 is the flow view showing the immersion plating.

### DESCRIPTION OF THE PREFERRED EMBODIMENT

The following description of the preferred embodiment is provided to understand the features and the structures of the present invention.

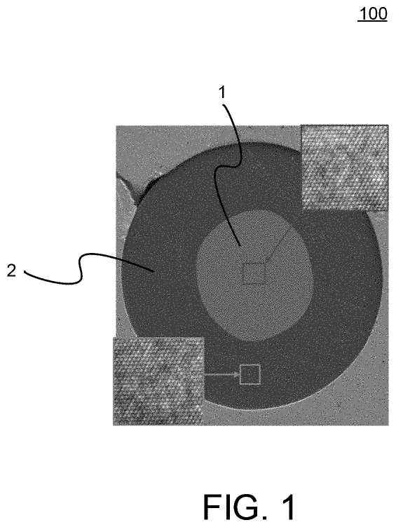

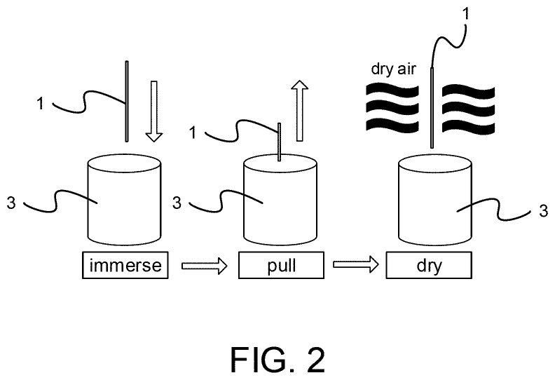

Please refer to FIG. 1 and FIG. 2, which are a structural view showing a preferred embodiment according to the present invention; and a flow view showing immersion plating. As shown in the figures, the present invention is a single-mode crystal fiber 100, comprising a core 1 and a coat 2.

The core 1 is made of a crystalline material with a melting point above 1900 degrees Celsius (° C.), which is made of a garnet crystal or a sapphire crystal like yttrium aluminium garnet (YAG).

The coat 2 is obtained through immersion plating and sintering under a vacuum pressure and a high temperature above 1800° C. to obtain a material the same as that of the core 1 as forming an outer layer covering the core 1, where the thickness of the coat 2 is between 0.05 micrometers (μm) and 10 millimeters (mm); and a single crystal totally the same as the material of the core 1 is grown in a solid state with no ceramics contained. Thus, a novel single-mode crystal fiber 100 is obtained.

In a state-of-use according to the present invention, a core 1 of a single-crystal sapphire fiber with a diameter below 30 μm is obtained. On preparing a crystal material for coating fiber, immersion plating is used to cover the core 1 with a coat 2 having the same material. The solution used for the immersion plating comprises 70 weight percent (wt %) of pure alumina (Al2O3) powder, 29.9 wt % of deionized water, and 0.1 wt % of silicon dioxide (SiO2), which forms a sapphire solvent and the powder size of the sapphire solvent is below 0.2 μm. The process flow of the immersion plating is shown in FIG. 2. The core 1 is immersed in a solvent containing the same material of the core 1 and, then, is dried. Therein, after each time of the immersing, the drying is a process of hot-drying with a dry air at a temperature of 200° C. For increasing the thickness of the coat 2, the immersing and drying is processed repeatedly for 20˜30 times with the core 1 until a required thickness of crystal covering the core 1 is obtained. Then, the coat 2 is sintered under a low vacuum pressure below 0.5 torr and a high temperature above 1800° C. to form a structure of a single crystal totally the same as the material of the core 1. Thus, the present invention uses the immersion plating to cover the core 1 with the same material whereas the thickness of the coat 2 is under control. In addition, the sintering is processed under vacuum and high temperature to obtain the coat 2 of a single crystal totally the same as the material of the core 1 as being grown in a solid state. Consequently, no ceramics are contained; and, through being sintered in a vacuum environment, the crystal has pores the smallest in size and the fewest in number, as compared to those sintered under normal pressures.

Hence, the present invention uses a core and a coat both of the same crystal structure to withstand high-power laser input or output. Because the coat and the core are of the same material with the same dispersion curve, a broadband single-mode range is thus obtained. The present invention is suitable for modulated single-mode lasers, which has a better dissipation than glass by using crystal. Therefore, as compared to coat glass with fiber, a better dissipation is obtained and low conversion efficiency due to thermal effect is reduced. All sizes of crystal fibers can be made with the sizes of coat adjustable according to requirement. As compared to copper cables, the single-mode crystal fiber according to the present invention has low transmission loss and is suitable for high-energy transmission, which can be applied to high-wattage lasers having wattages above 10 mW, broadband single-mode fiber systems, passive fast dissipation, optical-fiber high-energy transmission, steelworks, etc. for measuring the temperatures of high-temperature furnaces (by using high-temperature optical-fiber measuring heads, for example.)

To sum up, the present invention is a single-mode crystal fiber, where the present invention uses immersion plating to cover a core with a coat having the same material; the thickness of the coat is under control; sintering is processed under vacuum and high temperature to obtain a single crystal totally the same as the material of the core as being grown in a solid state with no ceramics contained; and, through being sintered in a vacuum environment, the crystal has pores the smallest in size and the fewest in number.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A single-mode crystal fiber, comprising
a core,
wherein said core is made of a crystalline material with a melting point above 1900 degrees Celsius (° C.); and
a coat,
wherein, through immersion plating and sintering under a vacuum pressure and a high temperature above 1800° C., a material of said coat the same as that of said core is obtained to form an outer layer covering said core,
wherein the thickness of said coat is between 0.05 micrometers (μm) and 10 millimeters (mm); and a single crystal of said coat totally the same as the material of said core is grown in a solid state with no ceramics contained.

2. The fiber according to claim 1,
wherein said coat is obtained through steps of: processing immersing to said core with a solvent containing the same material of said core and, then, processing drying; processing said immersing and said drying a plurality of times until a required thickness of crystal covering said core is obtained; and sintering said coat under a vacuum pressure and a low pressure below 0.5 torr to form a single crystal totally the same as the material of said core.

3. The fiber according to claim 2,
wherein the powder size of said solvent is below 0.2 μm.

4. The fiber according to claim 1,
wherein said core is made of a crystal selected from a group consisting of a garnet crystal and a sapphire crystal.

5. The fiber according to claim 4,
wherein said garnet crystal is a crystal of yttrium aluminium garnet (YAG).

6. The fiber according to claim 2,
wherein said drying is hot-drying with a dry air at a temperature of 200° C.±20%.

7. The fiber according to claim 1,
wherein the fiber is applied in fields of high-wattage lasers, broadband single-mode fiber systems, passive fast dissipation, optical-fiber high energy transmission, and high-temperature optical-fiber measuring heads.

8. The fiber according to claim 7,
wherein said high-wattage lasers have wattages above 10 milliwatt (mW).
